(19) United States
(12) Patent Application Publication
(10) Pub. No.: US 2006/0284990 A1
(43) Pub. Date: Dec. 21, 2006

(54) Method for taking a picture of a subject automatically in a digital camera

(75) Inventors: David Ho, Taipei (TW); Ping Zhang, Shanghai (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/452,910

(22) Filed: Jun. 15, 2006

(30) Foreign Application Priority Data
Jun. 15, 2005 (TW) 094119809

(51) Int. Cl. H04N 5/228

(52) U.S. Cl. 348/222.1

(57) ABSTRACT

The present invention is to provide a method for taking a picture of a subject automatically in a digital camera including an image capturing unit, a CPU, a memory unit, a storage unit and a scanning program, comprising the steps of giving an image capturing instruction to the CPU for successively capturing images through the scanning program; causing the CPU to command the image capturing unit to successively capture at least a first image and a second image of a subject; storing the first image and the second image in the memory unit; causing the CPU to compare the first image and the second image by using the scanning program; generating an activating signal by the scanning program when contents of the first image and the second image are different; and causing the CPU to store the second image in the storage unit as the picture taken of the subject.

### FIELD OF THE INVENTION

The present invention relates to digital cameras and more particularly to a method for taking a picture of a subject automatically in a digital camera without using a typical self-timer.

### BACKGROUND OF THE INVENTION

Electronics industry has known a rapid, spectacular development in recent several decades. A variety of advanced electronic products are commercially available due to phenomenal strides in digital technology. This is a significant breakthrough of technology. In response to the development and advancement of electronics industry, consumers are more concerned about whether certain electronic product(s) can provide features to satisfy specific needs in addition to practicability and convenience thereof.

Conventionally, a photographer may operate a self-timer mounted on a digital camera to take a delayed picture. The self-timer, when enabled, gives a predetermined waiting duration between the pressing of shutter release and shutter firing. For a typical digital camera, the predetermined waiting duration is about 2 to 15 seconds. However, such period of time is typically insufficient for a photographer to walk or even run to a specific location to take a desired picture of himself or herself after enabling the self-timer and pressing the shutter release. Some advanced digital cameras or specific types of digital camera may have a prolonged setting time of its self-timer. Likewise, a picture is taken only when end of the countdown is reached. Unfortunately, it is still often that the set period of time is insufficient for a photographer to walk or even run to a specific location and adjust his or her pose prior to taking a picture of himself or herself after enabling the self-timer and pressing the shutter release. As a result, photograph quality is poor.

Thus, it is desirable among photographers to allow them to enable a self-timer function of a digital camera by their own will rather than being bound by the set time of the self-timer in picture taking. Otherwise, a poor picture may be taken with unnatural face and ugly pose printed thereon. An infrared remote control device for a digital camera to take a delayed picture is thus developed. In detail, the infrared remote control device comprises an infrared signal receiver mounted in the digital camera, and an infrared remote control to be held by the hand of a photographer. The infrared signal receiver is enabled when a photographer operates the infrared remote control to send a signal to the infrared signal receiver. In response, a self-timer function of the digital camera is enabled. However, the infrared remote control device is high in price. This in turn may decrease potential buyers. Further, it is highly possible of losing the infrared remote control if sufficient care is not taken since it is a separate device operable by wireless means. To the worse, it is difficult of purchasing the same again after being lost. Furthermore, it cannot meet consumer needs. Thus, so far as the present inventor is aware, such type of digital camera incorporating an infrared remote control device has had no market acceptance. Hence, it is desirable among manufacturers of the art to provide a novel method for taking a picture of a subject automatically in a digital camera without using a typical self-timer.

### SUMMARY OF THE INVENTION

After considerable research and experimentation, a method for taking a picture of a subject automatically in a digital camera without using a well known self-timer according to the present invention has been devised so as to overcome the above drawbacks of the prior art.

It is an object of the present invention to provide in a digital camera including an image capturing unit, a CPU, a memory unit, a storage unit, and a scanning program. A method for taking a picture of a subject automatically in a digital camera comprises the steps of giving to the CPU an instruction to successively capture images through the scanning program, causing the image capturing unit to successively capture a first image and a second image of a subject according to the image capturing instruction, storing the first image and the second image in the memory unit, comparing the first image and the second image stored in the memory unit by using the scanning program, and activating the CPU to store the second image in the storage unit as the picture taken of the subject through the scanning program if the first image is different from the second image.

The above and other objects, features and advantages of the present invention will become apparent from the following detailed description taken with the accompanying drawings.

### BRIEF DESCRIPTION OF THE DRAWINGS

FIG. 1 is a block diagram of a digital camera according to the invention;

FIG. 2 is a plan view depicting a comparison region according to a preferred embodiment of the invention;

FIG. 3 is a plan view depicting candidate regions and comparison region according to the preferred embodiment of the invention shown in FIG. 2;

FIG. 4 is a flowchart depicting a process for taking a picture according to a preferred embodiment of the invention; and

FIG. 5 is a flowchart depicting another process for taking a picture according to the preferred embodiment of the invention.

### DETAILED DESCRIPTION OF THE PREFERRED EMBODIMENTS

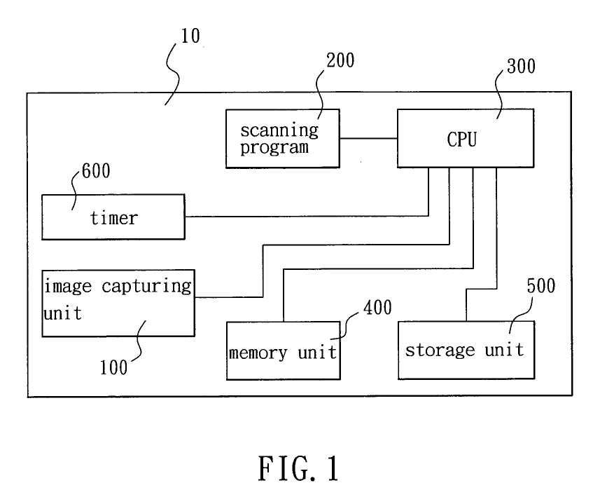

Referring to FIG. 1, a method for taking a picture of a subject automatically in a digital camera 10 without using a prior art self-timer in accordance with the invention is shown. The digital camera 10 comprises an image capturing unit 100, a CPU (central processing unit) 300, a memory unit (e.g., DRAM) 400, a storage unit (e.g., Memory Stick) 500, and a scanning program 200. The scanning program 200, when run, may continuously send an image capturing instruction to the CPU 300. Then the CPU 300 commands the image capturing unit 100 to successively capture at least a first image and a second image of a subject, wherein the two images are consecutive and the second image is after the first image in time. Then the first image and the second image are stored in the memory unit 400. Next, the CPU 300 may command the scanning program 200 to compare the first image and the second image stored in the memory unit 400. An activating signal is generated by the scanning program 200 when the first image is different from the second image. Next, the CPU 300 stores the second image in the storage unit as the picture taken of the subject in response to the activating signal.

In one embodiment of the invention the image capturing unit 100 divides the first image and the second image respectively into a plurality of pixels. Color of the pixel is represented by utilizing the composition principles of red (R), green (G), and blue (B). Values of R, G, and B colors are combined as a color value by substituting them for a mathematic expression. Each of values of R, G, and B colors is in a range of 0 to 255. For example, color value=value of R color+value of G color×256+value of B color ×65536 (i.e., 256×256). Values of R, G, and B colors of the pixel in the first image and the second image are stored in the memory unit 400 respectively. Thus, the CPU 300 may compare color values of the first image and the second image with each other. It is determined that the first image and the second image are different and an activating signal is generated when their color values are different. Next, the scanning program 200 is run for storing the second image in the storage unit 500 in response to the activating signal. On the contrary (i.e., when their color values are the same), the CPU 300 will continuously to compare two consecutive images in order to determine whether their color values are the same or not.

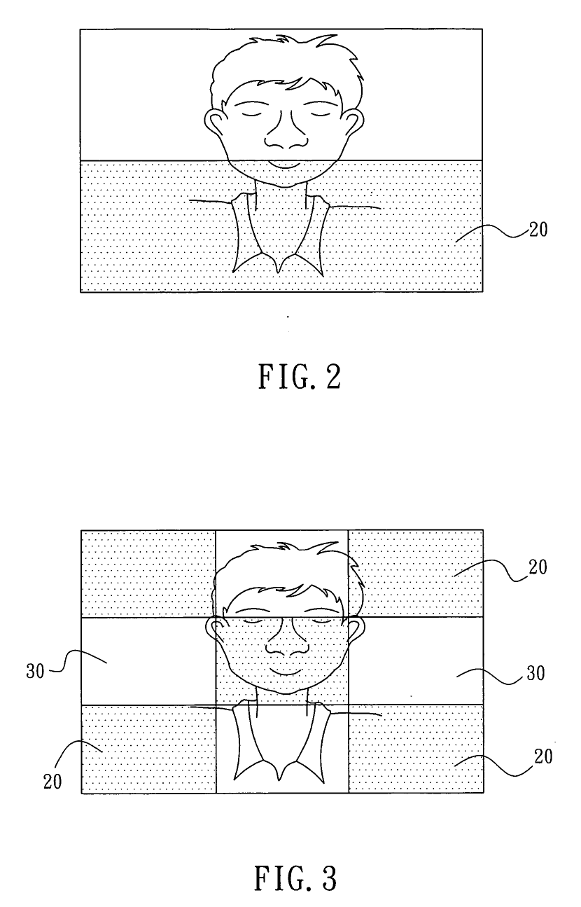

Pictures to be taken may be not focused due to external factors (e.g., wind, inhaling, exhaling or the like) whether avoidable or not. And in turn, an erroneous signal may be sent to the digital camera 10. As a result, an activating signal is generated to store the second image in the storage unit 500 in an undesired time. This finishes the picture taking. However, it may bring inconvenience to photographers or render a picture of poor quality. Thus, referring to FIG. 2, in the embodiment the scanning program 200 sets a portion of the image as a comparison region 20. The scanning program 200 only compares the comparison region 20 (i.e., omits other regions). For example, the scanning program 200 may take any changes above a height or besides a width of a subject to be taken as meaningful. The scanning program 200 may generate an activating signal when such occurs. In operation according to the invention a photographer may press the shutter release of the digital camera 10 to run the scanning program 200 in which a region above the shoulder of a subject (e.g., human being) is set as a comparison region 20 of images. That is, any changes in regions below the shoulder will not generate an activating signal. For example, a person shaking his or her hand(s) besides the shoulder may change images. And in turn, an activating signal is generated. Eventually, a picture is taken. Advantageously, the taken picture has a high quality since the timing of taking the picture is optimal.

Referring to FIG. 3, the scanning program 200 may divide the image into a plurality of candidate regions 30 in which one of the candidate regions 30 is taken as a comparison region 20 for comparison and any changes in regions other than the comparison region 20 are omitted. For example, an image is divided into 9 (3×3) candidate regions 30 in which the central candidate region 30 is taken as a comparison region 20 for comparison and other candidate regions 30 are not taken for comparison.

For solving the problem of picture to be taken being not focused due to undesired external factors resulting in a poor picture taken in an undesired timing or causing inconvenience to photographer, another embodiment of the invention is provided. In this embodiment, the scanning program 200 sets a comparison parameter representing an image data difference between the first image and the second image. Next, the scanning program 200 compares the first image and the second image. An activating signal will be generated when a difference between the first image and the second image is beyond a range of the comparison parameter. Based on the difference, the comparison parameter may be set as an allowable range of color value which is adjustable. For example, the greater the comparison parameter is the smaller the probability of generating an activating signal will be. On the contrary, the smaller the comparison parameter is the greater the probability of generating an activating signal will be.

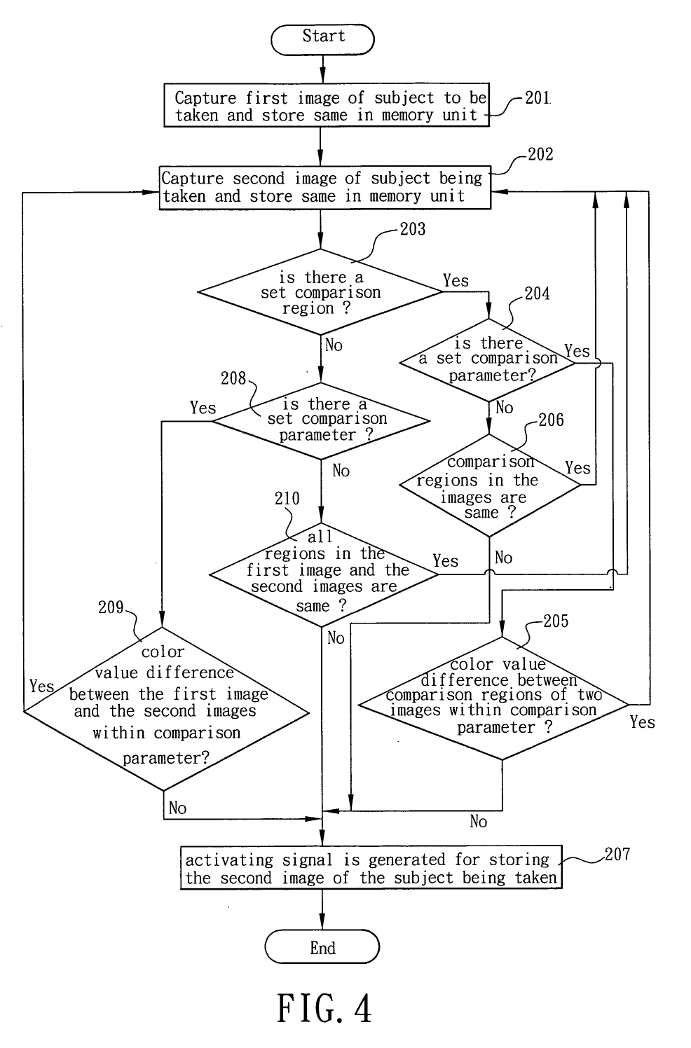

Referring to the flow chart of FIG. 4, a plurality of picture taking steps are performed by the invention when the shutter release of the digital camera 10 is pressed.

In step 201, capture a first image data of a subject to be taken and store same in the memory unit 400.

In step 202, capture a second image data of the subject being taken and store same in the memory unit 400.

In step 203, it is determined whether there is a set comparison region 20 in the scanning program 200. If yes, the process goes to step 204. Otherwise, the process jumps to step 208.

In step 204, it is determined whether there is a set comparison parameter in the scanning program 200. If yes, the process goes to step 205. Otherwise, the process jumps to step 206.

In step 205, it is determined whether color value difference between comparison regions 20 of the first image and the second image is within the range of comparison parameter or not based on the comparison parameter. If yes, the process loops back to step 202. Otherwise, the process jumps to step 207.

In step 206, it is determined whether contents of the comparison regions 20 in the first image and the second image are the same or not. If yes, the process loops back to step 202. Otherwise, the process goes to process 207.

In step 207, an activating signal is generated for storing the second image of the subject being taken. The process ends successfully.

In step 208, it is determined whether there is a set comparison parameter in the scanning program 200. If yes, the process goes to step 209. Otherwise, the process jumps to step 210.

In step 209, it is determined whether color value difference between the first image and the second image is within the range of comparison parameter or not based on the comparison parameter. If yes, the process loops back to step 202. Otherwise, the process loops back to step 207.

In step 210, it is determined whether contents of all regions in the first image and the second image are the same or not. If yes, the process loops back to step 202. Otherwise, the process loops back-to step 207.

Referring to FIG. 1 again, in another embodiment of the invention the digital camera 10 further comprises a timer 600. The timer 600 can be set for timing a predetermined waiting duration. Thus, the scanning program 200 will be run by the digital camera 10 after reaching the predetermined waiting duration. Hence, a photographer has a sufficient time to walk to a specific location to take a picture of himself or herself by means of the digital camera 10 after running the scanning program 200. Alternatively, after running the scanning program 200 and in response to any changes between the first image and the second image, another activating signal is generated by the scanning program 200 so as to enable the timer 600. The digital camera 10 will generate an activating signal for taking a picture after reaching the predetermined waiting duration. In such a manner, a photographer has a sufficient time to smile or adjust pose in order to take a picture of himself or herself prior to shutter firing.

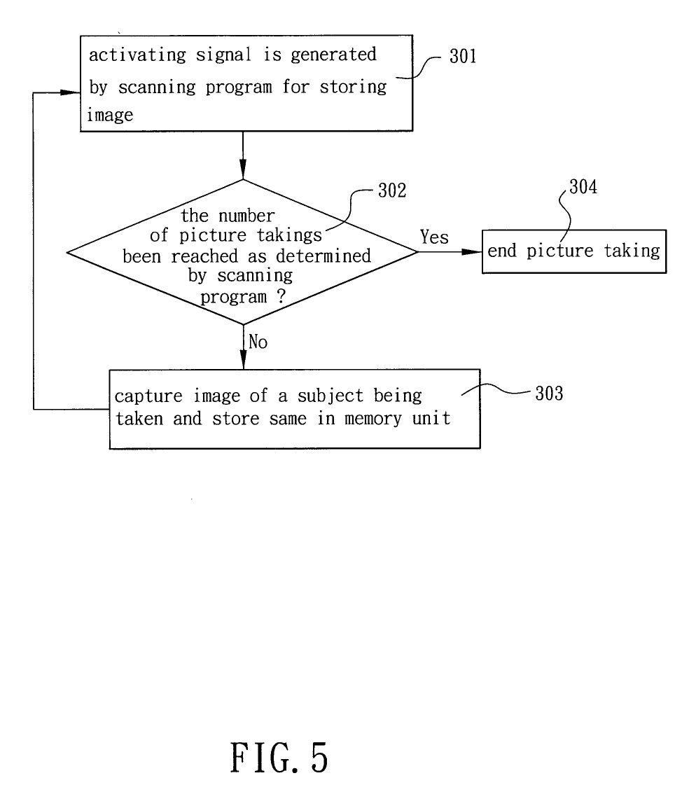

Referring to FIG. 1 again, in still another embodiment of the invention a predetermined number of picture takings is set by the scanning program 200. The scanning program 200 can continuously store a plurality of records of images after comparison based on the predetermined number of picture takings in which the number of the records of image data is equal to the predetermined number of picture takings. Referring to the flowchart of FIG. 5, a plurality of steps are performed as below by the invention after changing the images and initializing a count (i.e., count equals to zero).

In step 301, an activating signal is generated by the scanning program 200 by increasing the count by one. The activating signal is adapted to store the image.

In step 302, it is determined by the scanning program 200 whether the count is equal to the predetermined number of picture takings. If yes, the process jumps to step 304. Otherwise, the process goes to step 303.

In step 303, capture image of a subject being taken and store same in the memory unit 400.

In step 304, end the picture taking.

In view of above, the invention can overcome the prior art drawback of a photographer being unable to have a sufficient time to prepare a desired delayed shooting of himself or herself. It is contemplated by the invention that the memory unit 400 is utilized to compare any two consecutive records of images in order to find any image difference therebetween. After any image difference is found, the delayed shooting of the digital camera is performed. By utilizing the invention, a photographer has a sufficient time to prepare a desired delayed shooting of himself or herself in a right time. As a result, a high quality photograph is rendered rather than a poor one due to rush.

While the invention herein disclosed has been described by means of specific embodiments, numerous modifications and variations could be made thereto by those skilled in the art without departing from the scope and spirit of the invention set forth in the claims.

What is claimed is:

1. A method for taking a picture of a subject automatically in a digital camera including an image capturing unit, a central process unit (CPU, a memory unit, a storage unit, and a scanning program, comprising the steps of:
the scanning program giving to the CPU an instruction to successively capture images;
the CPU causing the image capturing unit to successively capture at least a first image and a second image of the subject according to the image capturing instruction, wherein the two images are consecutive and the second image is after the first image in time;
storing the first image and the second image in the memory unit;
the CPU comparing, the first image and the second image stored in the memory unit by using the scanning program,; and
if the first image is different from the second image, the scanning program activating the CPU to store the second image in the storage unit as the picture taken of the subject.

2. The method of claim 1, wherein the image capturing unit divides the first image and the second image respectively into a plurality of pixels, and the color of each pixel is formed by utilizing the RGB(red (R), green (G), and blue (B)) color model; the RGB values of each pixel of the first image and the second image are stored in the memory unit; and the CPU compares the first image and the second image by comparing the color values of the first image and the second image.

3. The method of claim 2, wherein the scanning program compares a region of the first image and a corresponding region of the second image, but does not compare the entire first image and the entire second image.

4. The method of claim 3, wherein the scanning program divides the first image and the second image respectively into a plurality of candidate regions, and compares one of the candidate regions of the first image with a corresponding candidate region of the second image.

5. The method of claim 2, wherein the scanning program sets a comparison parameter representing an image data difference between the first image and the second image resulting from comparing the first image and the second image by the scanning program; and when the value of the comparison parameter is beyond an allowable range, the scanning program activates the CPU to store the second image in the storage unit.

6. The method of claim 5, further comprising a step of determining whether or not the value of the comparison parameter is beyond the allowable range.

7. The method of claim 1, wherein the digital camera further comprises a timer for timing a predetermined waiting duration such that the scanning program is activated as soon as the predetermined waiting duration ends.

8. The method of claim 7, wherein if the first image is different from the second image after the scanning program is activated, the scanning program activates the timer to time the predetermined waiting duration and thereafter the scanning program activates the CPU to store the second image in the storage unit as soon as the predetermined waiting duration ends.
